(19) United States
(12) Patent Application Publication
(10) Pub. No.: US 2003/0211301 A1
(43) Pub. Date: Nov. 13, 2003

(54) Glass particles as detackifying agent in adhesive/sealant material and process for packaging the same

(76) Inventors: Theodore R. Flint, Elversson, PA (US); Paul Ewings, Ripley (GB)

Correspondence Address: SAMUEL W. APICELLI, DUANE MORRIS LLP, 305 NORTH FRONT STREET, P.O. BOX 1003, HARRISBURG, PA, 17108-1003, US

(21) Appl. No.: 10/464,256

(22) Filed: Jun. 18, 2003

Related U.S. Application Data
(63) Continuation of application No. 09/753,647, filed on Jan. 3, 2001.

(51) Int. Cl. B32B 3/00

(52) U.S. Cl. 428/202; 428/206; 428/208

(57) ABSTRACT

The invention provides an adhesive/sealant compound having an outer surface including a coating of substantially regularly shaped particles so as to reversibly detackify the outer surface. In one embodiment of the invention, an adhesive/sealant compound is provided having an outer surface comprising a coating of substantially spherical particles so as to reversibly detackify the outer surface. In another embodiment of the invention, an adhesive/sealant compound is provided having an outer surface comprising a coating of substantially spherical glass microballoons so as to reversibly detackify the outer surface wherein the spherical glass microballoons have diameters in the range of 0.2 millimeters to 0.6 millimeters. A process for packaging an adhesive/sealant compound is also disclosed.

### FIELD OF THE INVENTION

The present invention generally relates to adhesives and sealants provided in the form of a block or an extruded stick, and more particularly to devices for reducing the tackiness of the surface of those block or extruded sticks.

### BACKGROUND OF THE INVENTION

Consumers and craftsman have become familiar with a type of adhesive/sealant provided in the form of an extruded stick with a concentric curing agent component formed on the inside. It is known to package such extruded sticks as hand moldable epoxy putty sticks, with a release film or shrink wrap that is easily handled and does not stick to the container or the user of the stick. The user merely peels the release film or shrink wrap from the surface of the moldable epoxy putty stick to be ready for use. This action reveals the “tacky” surface of the epoxy stick for application to an intended surface, but which can also adhere to unintended surfaces as well during handling. The adherence of this tacky surface to portions of the machinery used to package such sticks, e.g., shrink wrapping machinery, is a particularly significant problem in the art. The shrink wrap and releasable film must also be discarded causing environmental concerns.

As a consequence, a material has been sought to provide a very thin, non-tacky coating to the moldable epoxy putty stick which would not become an unsightly, lumpy material in the mixed product. The coating needs to stay on and not be removed, and also to become an integral, chemically compatible part of the cured epoxy adhesive/sealant. Importantly, the coating should not be detrimental to the strength or other properties of the mixed and cured epoxy adhesive/sealant.

### SUMMARY OF THE INVENTION

The present invention provides an adhesive/sealant compound having an outer surface comprising a coating of substantially regularly shaped particles so as to reversibly detackify the outer surface.

In one embodiment of the invention, an adhesive/sealant compound is provided having an outer surface comprising a coating of substantially spherical particles so as to reversibly detackify the outer surface.

In another embodiment of the invention, an adhesive/sealant compound is provided having an outer surface comprising a coating of substantially spherical glass microballoons or solid glass beads so as to reversibly detackify the outer surface wherein the spherical glass microballoons or glass beads have diameters in the range of 0.2 millimeters to 0.6 millimeters.

A process for the packaging of an adhesive/sealant compound is also provided comprising applying a coating of substantially regularly shaped particles to an outer surface of an adhesive/sealant compound so as to reversibly detackify the outer surface. The coated adhesive/sealant compound is than operated upon by a shrink wrapping machine so as to package the adhesive/sealant compound by wrapping the adhesive/sealant compound in a heat shrinkable polymer. In this way, the heat shrinkable polymer shrinks uniformly over and around the adhesive/sealant compound without adhering to the coated outer surface.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of a portion of an extruded adhesive/sealant stick having a reversibly detackified surface according to the invention;

FIG. 2 is a partial cross-sectional view of the adhesive/sealant stick shown in FIG. 1; and

FIG. 3 is a cross-sectional view of the adhesive/sealant stick shown in FIG. 1, after it has been kneaded and/or molded prior to application to a surface.

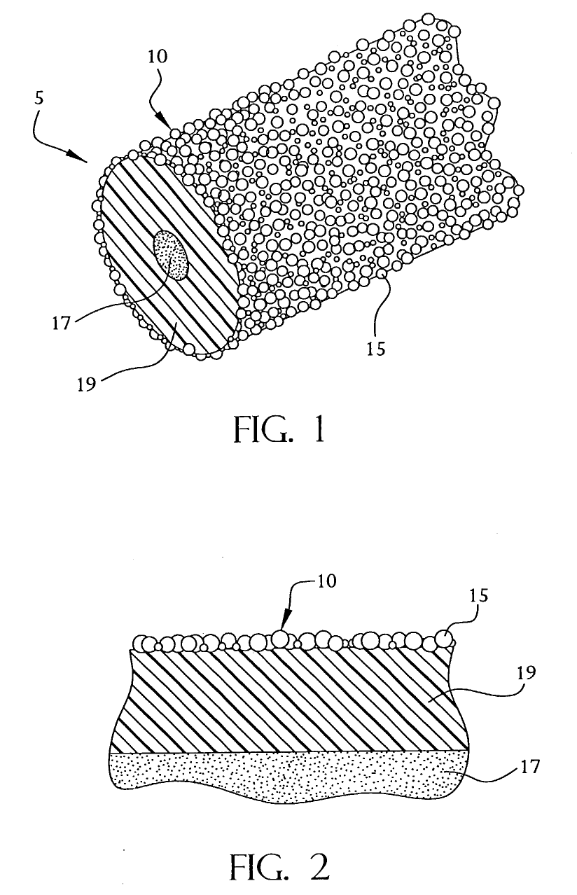

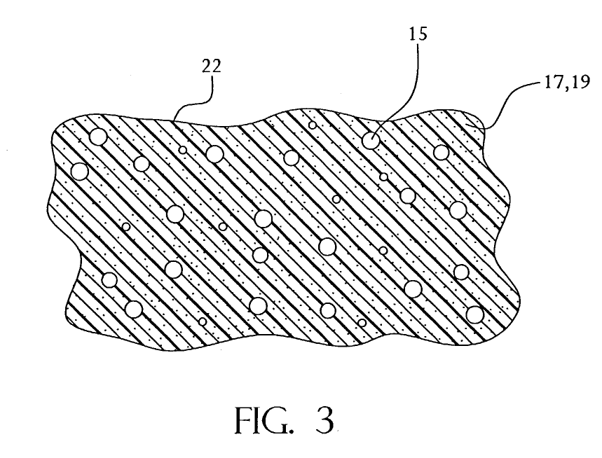

### DETAILED DESCRIPTION OF THE PREFERRED EMBODIMENT

This description of preferred embodiments is intended to be read in connection with the accompanying drawings, which are to be considered part of the entire written description of this invention. A preferred embodiment of the present invention is directed to an extruded stick 5 of hand moldable adhesive/sealant, e.g., epoxy putty, having a reversibly detackified surface 10 comprising a coating of particles 15. The adhesive/sealant stick that is used in one embodiment of the invention comprises an inner core of activating or curing agent 17 surrounded by a layer of adhesive/sealant material 19. Unlike the prior art, which has employed a covering of release film, shrink wrap, paper, or finely divided powders, e.g., talc or the like, the surface of adhesive/sealant material 19 is protected by a layer of non-tacky regularly shaped particulate material 15 which reversibly detackifies the adhesive surface.

As used in this disclosure, the terminology “reversibly detackify, reversible detackification, or reversibly detackified” refers to a quality, characteristic, or process associated with a substance that normally comprises adhesive, tacky, or sticky surface properties by which those adhesive, tacky, or sticky surface properties are not evident upon the application of light pressure such that the substance does not adhere or, only weakly adheres, to the source of that light pressure, but which substance is capable of adhering to a source of moderate pressure. The terminology “moderate pressure” refers to an amount of pressure which is sufficient to displace or submerge a coating of particles 15 into adhesive/sealant material stick 5 so that coating of particles 15 is subsumed within the bulk of the adhesive/sealant material. For example, moderate pressure is applied to adhesive/sealant material stick 5 during kneading, molding and/or forming of the material into a useful form.

According to one embodiment of the present invention, once an adhesive/sealant material has been extruded into an easily usable form, e.g., a stick or block 5, it is coated with non-tacky regularly shaped particles 15. The amount of non-tacky regularly shaped particles 15 adhered to the surface of adhesive/sealant material 19 should be sufficient to detackify the surface. This amount may be equal to the theoretical amount required to completely cover the entire surface area of adhesive/sealant material stick 5 or, may be significantly less than this amount depending on the size of the particles used and the degree of detackification desired. In one embodiment, the amount of particles 15 is less than the theoretical amount which would be necessary to completely cover the surface area of adhesive/sealant material stick 5, and is preferably an amount which is more than about 90% of the total surface area of adhesive/sealant material stick 5. Thus layer of non-tacky particles 15 applied to the surface of adhesive/sealant stick 5 is in an amount effective to inhibit the surface of adhesive/sealant stick 5 from adhering to a surface upon the application of light pressure to the adhesive. Suitable amounts of non-tacky particles 15 which may be applied to the surface of adhesive/sealant stick 5 can range from 90 to 99.9% of the surface area, and is preferably in the range of from 95 to 99.9% of surface area.

The particles can be applied by a powder coating process, can be simply sprayed or rolled onto the surface of adhesive/sealant material stick 5 on a moving web, or can be applied by other known methods of applying particles to surfaces. It is considered an important feature of the present invention that the reversibly detackified surface of extruded hand moldable adhesive/sealant material stick 5 provide a relatively non-stick or non-adhesive quality to adhesive/sealant material stick 5 during normal handling, and prior to activation of the epoxy by kneading or squeezing under moderate pressure sufficient to thoroughly mix activating or curing agent 17 with adhesive/sealant material 19.

Suitable non-tacky regularly shaped particles 15 for use in the present invention include any non-tacky regularly shaped particulate matter which sufficiently detackifies the surface of adhesive/sealant material stick 5 to prevent permanent adherence to a surface, but which does not deleteriously affect the bond strength between that surface and the surface to which it is intended to be applied. In general, such suitable non-tacky regularly shaped particulate matter has an average particle size in a range of from about 0.6 to 0.8 millimeters (mm) and may be as large as 1.8 mm in a non-preferred form of the invention.

For example, glass microballoons or solid glass beads having diameters in the range of 0.2 millimeters to 0.6 millimeters have been coated onto adhesive/sealant material sticks and resulted in a non-tacky surface that is essentially permanent, i.e., stable in the presence of light pressure. Spheres of this diameter have been able to inhibit the creep of the viscous liquid resin of adhesive/sealant material 19 for substantially long periods of time, suitable for long term storage. Spheres or beads in the 0.6 millimeter to 0.8 millimeter diameter range also achieved the same effect. Spheres or beads in the range of 0.8 millimeters but less than 1.8 millimeters result in a non-tacky surface but become obvious in the mixed product as discreet particles and may be undesirable to the user. Glass spheres or glass beads that are clear or colorless, i.e., impart little or no coloration to the surface of adhesive/sealant material stick 5, have been found to be particularly preferred when used in connection with shrink wrapping. However, for certain purposes such diameter beads or even larger may be acceptable even if used to indicate degree of mixing. The non-tacky particles 15 may also comprise organic, inorganic or a mixture of organic and inorganic particles. It is considered important if that non-tacky organic particulate material 15 is used to coat the surface of extruded hand moldable adhesive/sealant material stick 5, it not be soluble in adhesive/sealant 19.

Significantly, coating epoxy putty sticks with spherical or uniformly shaped particles 15 allows the sticks of epoxy putty to be fed easily into and through a conventional packaging machine (e.g., a shrink wrapping machine) without sticking or causing damage to the machine or, destroying the epoxy putty sticks themselves due engagement to the machine's parts. Advantageously, coating adhesive/sealant material stick 5 with substantially dry particles, without substantially changing the color of the stick, allows shrink-wrapping to be performed far more effectively than is known in the art. If adhesive/sealant material stick 5 is coated so as to be fully compatible with conventional shrink wrapping machinery, smaller beads are preferred, e.g., glass beads having a diameter of less than about 0.2 millimeters. This size bead does not create a long lasting non-tacky surface on adhesive/sealant material stick 5, but once shrink-wrapped, it is not important if the tacky surface returns.

It will be understood that shrink-wrappable materials are well known, and available on the commercial market. A shrink-wrappable material generally comprises an oriented thermoplastic sheeting which, when heated, shrinks in the oriented direction adhering to itself and the wrapped product in the process. When used in connection with the present invention, the shrinking polymer shrinks more uniformly over and around adhesive/sealant material stick 5, without wrinkles, because the shrink wrap plastic slides over particles 15, as it shrinks. Any commonly used shrink-wrappable thermoplastic may be used in connection with the present invention, e.g., polyvinylchloride, polyvinylacetate, polyolefins, and the like. Conventional shrink wrapping machines, such as any of the ones that are taught in U.S. Pat. Nos. 5,956,931; 5,941,052; 5,619,843; 5,371,999; and 4,341,057, or the like, may be used to package adhesive/sealant material stick 5 in accordance with the process of the present invention with good results. The foregoing patents are hereby incorporated herein by reference.

It is to be understood that the present invention is by no means limited only to the particular constructions herein disclosed and shown in the drawings, but also comprises any modifications or equivalents within the scope of the claims.

What is claimed is:

1. An adhesive/sealant compound having an outer surface comprising a coating of substantially regularly shaped particles so as to reversibly detackify said outer surface.

2. An adhesive/sealant compound according to claim 1 wherein said coating completely covers said outer surface.

3. An adhesive/sealant compound according to claim 1 wherein said coating covers less than the theoretical amount which would be necessary to completely cover said outer surface.

4. An adhesive/sealant compound according to claim 1 wherein said coating covers said outer surface by an amount which is more than about 90% of the total surface area of said adhesive/sealant compound.

5. An adhesive/sealant compound according to claim 1 wherein said coating is in an amount effective to inhibit the surface of said adhesive/sealant compound from adhering to a surface upon the application of light pressure.

6. An adhesive/sealant compound according to claim 1 wherein said coating covers between 90% to 99.9% of said outer surface.

7. An adhesive/sealant compound according to claim 1 wherein said coating covers between 95% to 99.9% of said outer surface.

8. An adhesive/sealant compound according to claim 1 wherein said coating of substantially regularly shaped particles comprises an average particle size in a range of from about 0.2 millimeters to 0.6 millimeters.

9. An adhesive/sealant compound according to claim 1 wherein said coating of substantially regularly shaped particles comprises an average particle size in a range of from about 0.6 to 0.8 millimeters.

10. An adhesive/sealant compound according to claim 1 wherein said coating of substantially regularly shaped particles comprises an average particle size in a range of from about 0.8 millimeters to 1.8 millimeters.

11. An adhesive/sealant compound according to claim 1 wherein said coating of substantially regularly shaped particles comprise glass microballoons.

12. An adhesive/sealant compound according to claim 1 wherein said coating of substantially regularly shaped particles comprise glass beads.

13. An adhesive/sealant compound according to claim 1 wherein said coating of substantially regularly shaped particles comprise glass microballoons having diameters in the range of 0.2 millimeters to 0.6 millimeters.

14. An adhesive/sealant compound according to claim 1 wherein said coating of substantially regularly shaped particles comprise glass beads having diameters in the range of 0.2 millimeters to 0.6 millimeters.

15. An adhesive/sealant compound according to claim 1 wherein said coating of substantially regularly shaped particles comprise spheres.

16. An adhesive/sealant compound according to claim 15 wherein said spheres comprise a diameter able to inhibit the creep said adhesive/sealant compound for substantially long periods of time.

17. An adhesive/sealant compound according to claim 1 wherein said coating of substantially regularly shaped particles comprise organic particulate material.

18. An adhesive/sealant compound having an outer surface comprising a coating of substantially spherical particles so as to reversibly detackify said outer surface.

19. An adhesive/sealant compound according to claim 18 wherein said spherical particles are colorless.

20. An adhesive/sealant compound according to claim 19 wherein said spherical particles have diameters in the range of 0.2 millimeters to 0.6 millimeters.

21. An adhesive/sealant compound having an outer surface comprising a coating of substantially clear spherical glass microballoons so as to reversibly detackify said outer surface wherein said clear spherical glass microballoons have diameters in the range of 0.2 millimeters to 0.6 millimeters.

22. A process for packaging of an adhesive/sealant compound comprising;
(A) applying a coating of substantially regularly shaped particles to an outer surface of an adhesive/sealant compound so as to reversibly detackify said outer surface; and
(B) operating a shrink wrapping machine so as to package said adhesive/sealant compound by wrapping said adhesive/sealant compound in a heat shrinkable polymer whereby when heated said heat shrinkable polymer shrinks uniformly over and around said adhesive/sealant compound without adhering to said coated outer surface.

23. A process for packaging of an adhesive/sealant compound comprising;
operating a shrink wrapping machine so as to package an adhesive/sealant compound having an outer surface comprising a coating of substantially regularly shaped glass beads that reversibly detackify said outer surface whereby shrinking plastic applied by said shrink wrapping machine to said adhesive/sealant compound shrinks uniformly over and around said adhesive/sealant compound.
